(19) United States
(12) Patent Application Publication
(10) Pub. No.: US 2025/0291816 A1
(43) Pub. Date: Sep. 18, 2025

(54) INFORMATION PROCESSING DEVICE

(71) Applicant: TOYOTA JIDOSHA KABUSHIKI KAISHA, Toyota-shi (JP)

(72) Inventors: Koichi OKUDA, Toyota-shi (JP); Hideaki Bunazawa, Tokyo (JP); Atsushi Tabata, Okazaki-shi (JP); Ken Imamura, Toyota-shi (JP)

(73) Assignee: TOYOTA JIDOSHA KABUSHIKI KAISHA, Toyota-shi (JP)

(21) Appl. No.: 18/965,101

(22) Filed: Dec. 2, 2024

(30) Foreign Application Priority Data
Mar. 13, 2024 (JP) 2024-038669

(51) Int. Cl. G06F 16/28

(52) U.S. Cl. CPC G06F 16/285

(57) ABSTRACT

A processing device of an information processing device performs a search process including: a first step of calculating a relative frequency distribution of the original data; a second step of setting a plurality of time windows for clipping data of a partial period of the original data; a third step of clipping data from the original data; a fourth step of calculating a relative frequency distribution in the extracted data; and a fifth step of calculating an error between the relative frequency distribution in the original data and the relative frequency distribution in the extracted data, and a trial from the second step to the fifth step being repeatedly performed by changing the setting of the time windows. In the second step, the time windows are set such that the ratio between the periods before and after the specific maintenance become equal to that in the entire original data.

### CROSS-REFERENCE TO RELATED APPLICATION

This application claims priority to Japanese Patent Application No. 2024-038669 filed on Mar. 13, 2024, incorporated herein by reference in its entirety.

### BACKGROUND

### 1. Technical Field

The present disclosure relates to information processing devices.

### 2. Description of Related Art

Japanese Unexamined Patent Application Publication No. 2008-108247 (JP 2008-108247 A) discloses an information processing device that reduces the size of data for analysis by compressing original data for analysis. The original data for analysis is data collected over a predetermined period using sensors mounted on the vehicle.

The information processing device disclosed in JP 2008-108247 A compresses data by extracting, from the original data, data acquired at the time when a certain vehicle speed is reached and data acquired at the time of an inflection point of the vehicle speed.

### SUMMARY

The above information processing device extracts data by focusing only on the vehicle speed. Therefore, the above information processing device cannot extract data according to characteristics of data other than the vehicle speed. There is a demand for an information processing device that can obtain extracted data capturing characteristics of the entire original data including a plurality of features.

An information processing device for solving the above issue reduces a volume of data to be used for analysis by extracting part of original data collected over a predetermined period using a plurality of sensors mounted on a vehicle. The information processing device includes a processing device configured to perform a process. In the information processing device, a search process that is performed by the processing device includes a first step of calculating, for each of a plurality of features included in the original data, a relative frequency distribution in the original data. The search process includes a second step of setting a plurality of time windows for clipping data of a partial period of the original data in such a manner that a sum of periods of all the time windows is shorter than the predetermined period. The search process includes a third step of clipping data from the original data according to the time windows. The search process includes a fourth step of calculating, for each of the features, the relative frequency distribution in extracted data obtained by combining all the data clipped according to the time windows, The search process includes a fifth step of calculating an error between the relative frequency distribution in the original data and the relative frequency distribution in the extracted data. In the search process, after the first step is performed, a trial from the second step to the fifth step is repeatedly performed by changing settings of the time windows. The processing device performs the search process to extract the extracted data with the error equal to or less than a threshold value. The processing device is configured to set, in the second step, the time windows in such a manner that ratios between data before specific maintenance and data after the specific maintenance in an entirety of the original data and the extracted data become equal.

In one aspect of the information processing device, the processing device may be configured to perform clustering. The clustering may be machine learning that groups data of each interval obtained by dividing the original data into intervals of a certain period into a predetermined number of clusters. The processing device may be configured to set, in the second step, the time windows in such a manner that a difference between a proportion of each of the clusters in the extracted data and a proportion of each of the clusters in the entirety of the original data is equal to or less than a threshold value.

This information processing device can find a setting that allows to obtain extracted data capturing characteristics of the entire original data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing device;

FIG. 2A is a graph of the original data, showing a change in oil flow rate;

FIG. 2B is a graph of the original data, showing a change in speed change frequency;

FIG. 3 is a flowchart illustrating a flow of processing performed by the processing device of the data center;

FIG. 4 is a graph showing an example in which original data is clustered using two features;

FIG. 5 is a graph showing an example of the relative frequency distribution for the flow rate of oil in the original data;

FIG. 6 is a graphical representation of the relative frequency distribution for the shift frequency in the original data; and

FIG. 7 is a graph illustrating an example of a relationship between an index value and a traveling time.

### DETAILED DESCRIPTION OF EMBODIMENTS

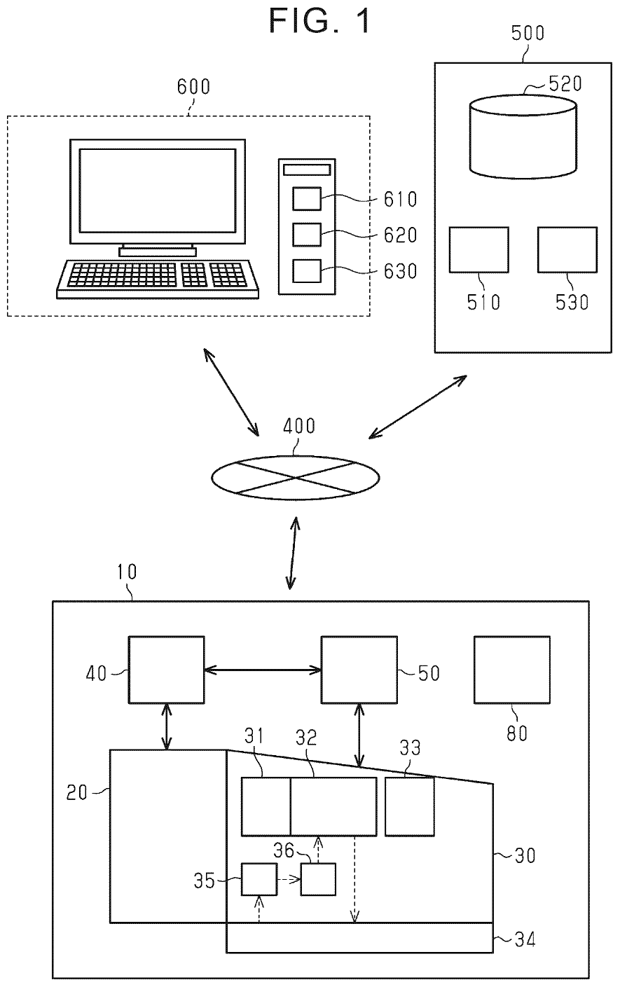

Hereinafter, a data center 500, which is an embodiment of an information processing device, will be described with reference to FIGS. 1 to 7.

### Configuration of Information Processing System

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of Data Center 500

As illustrated in FIG. 1, the data center 500 includes a processing device 510. The data center 500 includes a storage device 520 and a communication device 530. The processing device 510 includes a CPU that performs processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

The data center 500 may be configured using a plurality of computers. For example, the data center 500 can be composed of multiple server devices.

### Configuration of Vehicle 10

Each of the plurality of vehicles 10 includes a communication device 80. The communication devices 80 are implemented as hardware such as a network adapter, various communication software, or a combination thereof. These communication devices 80 are configured to realize wired or wireless communication via the communication network 400.

Each vehicle 10 is equipped with an engine 20 and an automatic transmission 30. For example, the automatic transmission 30 is a planetary gear type transmission. The automatic transmission 30 includes a frictional engagement device 31, a planetary gear train 32, and a hydraulic control circuit 33. Frictional engagement device 31 alters the combination of planetary gear trains 32 that transmit power by engaging or releasing a plurality of frictional engagement elements. Accordingly, the automatic transmission 30 forms a plurality of transmission stages having different gear ratios. The frictional engagement element is, for example, a clutch or a brake. The hydraulic control circuit 33 controls the hydraulic pressure supplied to the respective frictional engagement elements of the frictional engagement device 31.

The automatic transmission 30 includes an oil pan 34, a pump 35, and an oil filter 36. The pump 35 sucks the oil stored in the oil pan 34 and supplies the oil to the planetary gear train 32 via the oil filter 36. The oil recovered from the planetary gear train 32 is stored in the oil pan 34 again. The automatic transmission 30 may perform oil change as specific maintenance.

The vehicle 10 includes an engine control device 40 and a transmission control device 50. The engine control device 40 controls the engine 20. The transmission control device 50 controls the automatic transmission 30 by controlling the hydraulic control circuit 33. The transmission control device 50 supplies oil to the planetary gear train 32 by controlling the pump 35.

The engine control device 40 and the transmission control device 50 are equipped with various sensors that collect information on each part of the vehicle 10. In each vehicle 10, travel data is collected from the various sensors. The traveling data is transmitted from each vehicle 10 to the data center 500 by the communication device 80. For example, travel data including the travel distance, the position information, and the vehicle speed of each vehicle 10 is transmitted from each vehicle 10 to the data center 500. The travel data also includes various data indicating the state of the automatic transmission 30 acquired by the transmission control device 50 of the vehicle 10. Identification information for identifying the respective vehicles 10 is also transmitted from the respective vehicles 10 to the data center 500 together with the traveling data. Data indicating a history of maintenance of the automatic transmission 30 is also transmitted from each vehicle 10 to the data center 500 together with the traveling data.

The data center 500 stores the travel data together with the received identification information and the maintenance history in the storage device 520. In this way, traveling data of the plurality of vehicles 10 is accumulated in the storage device 520 of the data center 500.

### Configuration of Information Processing Terminal 600

The information processing terminal 600 includes a processing device 610, a storage device 620, and a communication device 630. The processing device 610 includes a CPU that performs processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of Vehicle 10

The information processing terminal 600 is used to analyze travel data. When analyzing the traveling data, an instruction for performing analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the oil filter 36 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the entire original data from a large amount of travel data that is the original data. If such extracted data can be extracted, the processing device 510 can perform analysis in a shorter time by using the extracted data. For example, in the case of estimating the damage of the oil filter 36 when the vehicle travels for 100,000 hours, the processing device 510 estimates the damage using the extracted data for 20,000 hours extracted from the original data for 100,000 hours. Then, the processing device 510 multiplies the index value calculated from the extracted data for 20,000 hours by 5 to calculate the index value of the damage of the oil filter 36 when the vehicle travels for 100,000 hours.

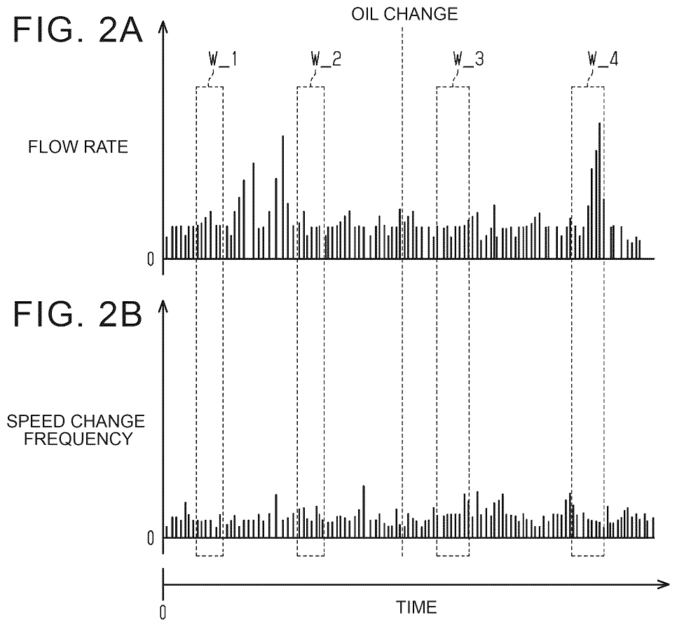

FIGS. 2A and 2B show exemplary original-data. The original data shown in FIGS. 2A and 2B is travel data for 100,000 hours in one vehicle 10. The original data shown in FIGS. 2A and 2B includes, as features, a flow rate of oil passing through the oil filter 36 to be subjected to calculation of an index value of damage, and a shift frequency of the automatic transmission 30.

FIG. 2A shows a change in oil flow rate for 100,000 hours. The flow rate of the oil can be detected by a flow rate sensor mounted on the vehicle 10. The flow rate of the oil may be calculated by the transmission control device 50. For example, the flow rate of the oil may be a discharge amount calculated from the standard of the pump 35, the number of revolutions, and the like.

FIG. 2B shows a change in shift frequency of the automatic transmission 30 for 100,000 hours. The shift frequency indicates the number of times the gear ratio is changed per fixed time. The transmission control device 50 calculates the shift frequency. The data in which the timing when the gear ratio is changed is recorded from the vehicle 10 may be transmitted to the data center 500, and the speed change frequency may be calculated in the data center 500. The shift frequency may be data indicating an interval of engagement using the same frictional engagement element.

The oil flow rate and the speed change frequency correlate with the damage of the oil filter 36 of the vehicle 10. The processing device 510 of the data center 500 estimates the damage of the oil filter 36 from the traveling data including the flow rate of the oil and the speed change frequency features.

The extracted data is created by clipping the data from the original data by a plurality of time windows. In FIGS. 2A and 2B, four time windows of the first time window W_1, the second time window W_2, the third time window W_3, and the fourth time window W_4 are indicated by broken lines, respectively, as the plurality of time windows. The beginning and end of each time window are set such that the respective time windows do not overlap. In this example, the traveling data for 20,000 hours is clipped as the extracted data. Therefore, the start and end periods of each time window are set so that the total length of the time periods of all the time windows is 20,000 hours.

When there is a history of specific maintenance, each time window is set so that the ratios between data before the specific maintenance and data after the specific maintenance in the entire original data and the extracted data become equal. For example, it is assumed that each of the ratios of the periods before and after the specific maintenance in the period of the entire original data is 50%. In this case, each time window is set such that 50% of the total time period of all time windows becomes a specific pre-maintenance period and 50% becomes a specific post-maintenance period.

The data center 500 searches for the setting of the start time and the end time of each time window indicating the clipping pattern for extracting the extracted data that captures the features of the entire original data.

The data center 500 extracts the extracted data from the original data by using the clipping pattern found by the search. The data center 500 performs analysis using the extracted data.

### Clipping Pattern Search Process

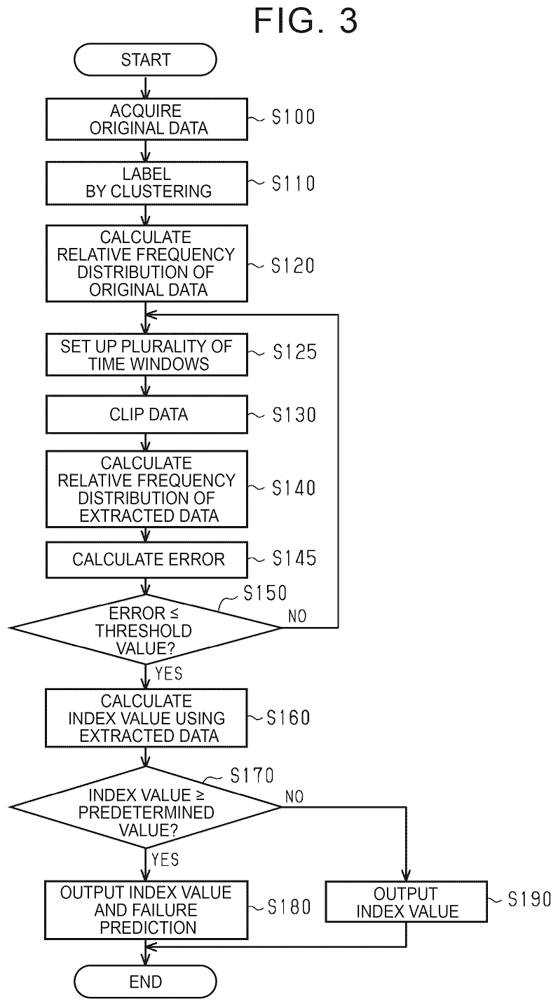

FIG. 3 is a flowchart illustrating a flow of a series of processes related to the clipping pattern search process. This series of processing is performed by the processing device 510 of the data center 500.

As illustrated in FIG. 3, the processing device 510 acquires the original-data in the processing of $100. The original data is a part of the travel data selected for the purpose of analysis from the enormous travel data stored in the storage device 520 of the data center 500. For example, the original data for calculating the index value indicating the magnitude of the damage accumulated in the oil filter 36 of one vehicle 10 is travel data for a predetermined period of the target vehicle 10 selected from the huge travel data of the plurality of vehicles 10. For example, in the case of estimating the damage of the oil filter 36 when the vehicle travels for 100,000 hours, the original data is traveling data over a predetermined period of the target vehicle 10.

In S110 process, the processing device 510 labels the original data by clustering. Specifically, the processing device 510 divides the original data at regular intervals. The length of the period for separating the original data is, for example, several minutes. Then, the processing device 510 performs clustering which is machine learning for classifying the data of each interval into a predetermined number of clusters. For example, k-means method is used as the algorithm of clustering. k-means method is a clustering algorithm for classifying data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the original data can be classified into clusters of travel data having similar characteristics. The number of clusters to be classified is arbitrarily set according to the contents of the analysis.

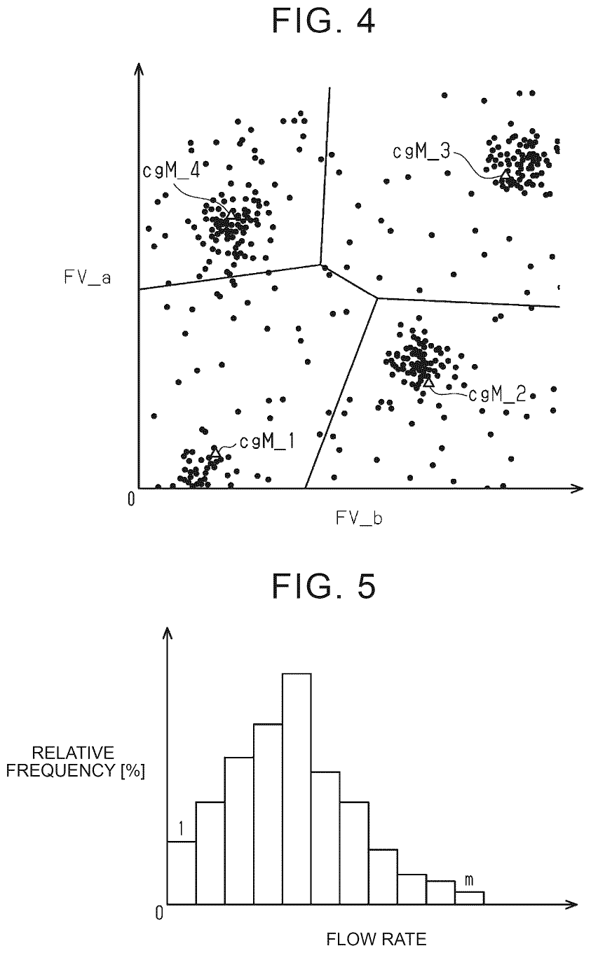

FIG. 4 is a graph illustrating an exemplary clustering of original data into four clusters by a k-means method using two features included in the original data as explanatory variables. For example, the two features are the flow rate and the speed change frequency of the oil shown in FIGS. 2A and 2B. In FIG. 4, each piece of data in each interval partitioned from the original data is indicated by a single point. When performing clustering, the processing device 510 uses a representative value of an explanatory variable in the data of each interval. For example, the processing device 510 sets the average value of the features in the data of each interval as a representative value. The processing device 510 may use, as the representative value, the moving average value of the features in a plurality of consecutive intervals in time series.

In FIG. 4, these points are shown in a two-dimensional space with the first feature FV_a and the second feature FV_b as coordinate axes. FIG. 4 is an example in which original data is clustered in four clusters of the first cluster M_1, the second cluster M_2, the third cluster M_3, and the fourth cluster M_4. In FIG. 4, the boundaries of the four clusters are indicated by solid lines. In FIG. 4, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 4 shows two examples of explanatory variables, the number of explanatory variables is not limited to two. For example, when the original data includes three features, the processing device 510 may perform clustering using these three features as explanatory variables. In this case, the processing device 510 clusters the original data in the three-dimensional coordinate space.

The processing device 510 assigns a label indicating the result of the clustering in this way to the original data. Specifically, each data indicated by a point in the coordinate space is given a label for identifying a cluster in which the data is classified. In this way, the processing device 510 creates the original data to which the label is attached.

Next, the processing device 510 calculates the relative frequency distribution of the original-data in the processing of S120. As described above, the original data includes a plurality of features. The processing device 510 calculates a relative frequency distribution in the original data for each feature.

The frequency distribution classifies data into a plurality of classes, and represents a frequency distribution that is the number of data of each class. The relative frequency indicates how much the frequency of the class accounts for the sum of the total frequencies.

FIG. 5 shows the relative frequency distribution for the flow rate of oil in the original data shown in FIG. 2A. In this relative frequency distribution, the grades of the flow rate of oil in the original data are divided into m grades from 1 to m to show the relative frequency distribution.

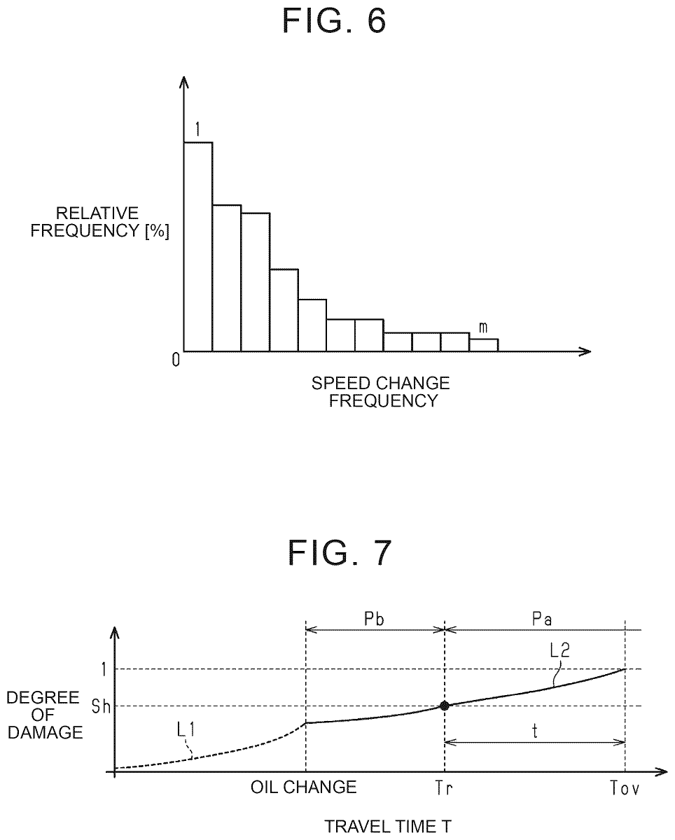

FIG. 6 is a graph showing the relative frequency distribution of the shift frequency in the original data shown in FIG. 2B. In this relative frequency distribution, the rank of the shift frequency in the original data is divided into m ranks from 1 to m, and the relative frequency distribution is shown.

In S120 process, the processing device 510 calculates the relative frequency distribution for the respective feature values included in the original data. The number of classes in the relative frequency distribution of each feature is the same.

For example, as shown in FIGS. 2A and 2B, when the original data includes two features, i.e., the flow rate of oil and the shift frequency, as the features, the processing device 510 calculates the relative frequency distributions of the two features.

Next, in S125 process, the processing device 510 sets a plurality of time windows in order to extract the extracted data from the original data.

In FIGS. 2A and 2B of the drawings, four time windows W_1 to W_4 of the first time window W_1, the second time window W_2, the third time window W_3, and the fourth time window W_4 are illustrated as exemplary time windows. In the example shown in FIGS. 2A and 2B, the time windows are all equal. As illustrated in FIGS. 2A and 2B, the data clipped according to the clipping windows is data of the respective features in the same time interval.

In S125 process, the processing device 510 randomly sets a plurality of time windows such that the total time period of all time windows is shorter than a predetermined period, which is the total time period of the original data. As will be described later, the processing device 510 combines all the data clipped by the time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window every time S125 process is performed. At this time, the processing device 510 sets each time window so that each time window does not overlap. The processing device 510 thus randomly sets the plurality of time windows such that the total period of all time windows is a preset period. In S125 process, the processing device 510 may set a plurality of time windows by fixing the time periods of the respective time windows to be constant, as illustrated in FIGS. 2A and 2B. In S125 process, the processing device 510 may fix the plurality of time windows to a fixed number and set the plurality of time windows.

When there is a history of specific maintenance, the processing device 510 sets a plurality of time windows so that the ratios of data before the specific maintenance and data after the specific maintenance in the entire original data and the extracted data are equal. In S125 process, the processing device 510 sets a plurality of time windows such that an absolute value of a difference between the ratio of the periods before and after the specific maintenance in the extracted data and the ratio of the periods period before and after the specific maintenance in the entire original data is equal to or less than a threshold value.

In addition to the above-described requirements, when setting a plurality of time windows through S125, the processing device 510 sets a plurality of time windows such that a difference between a proportion of each cluster in the extracted data and a proportion of each cluster in the entire original data is equal to or less than a threshold value.

In this way, by setting a plurality of time windows through S125 process, a clipping pattern in which data is clipped from the original data is determined. When the processing device 510 determines the clipping pattern in this way, the processing proceeds to S130.

In S130 process, the processing device 510 clips data from the original data in the determined clipping pattern. That is, in S130 process, the processing device 510 clips data from the original data by a plurality of set time windows. Then, the processing device 510 combines all the data clipped by the plurality of time windows to create extracted data.

In the process of the following S140, the processing device 510 calculates the relative frequency distribution of the extracted data. The processing device 510 calculates the relative frequency distribution of the extracted data in the same manner as the method of calculating the relative frequency distribution in S120. In other words, in S140 process, the processing device 510 calculates the relative frequency distribution of the extracted data for each feature value. At this time, the processing device 510 sets the number of grades in the relative frequency distribution of the respective features to be the same as the relative frequency distribution in S120.

For example, as in the example shown in FIGS. 2A and 2B, when the original data includes two features of the oil flow rate and the shift frequency as the features, the processing device 510 calculates the relative frequency distributions of the two features even in S140.

Next, in S145 process, the processing device 510 calculates an error between the relative frequency distribution in the original data and the relative frequency distribution in the extracted data. For example, the processing device 510 calculates a mean absolute error (MAE). The mean absolute error MAE is expressed by the following equation.

$$MAE = \frac{1}{n} {\sum }_{i = 1}^{nm} {\sum }_{j = 1}^{m} \vert {Y}_{nm} - {y}_{nm} \vert \qquad ( Mathematical formula 1 )$$

In the above equation, “n” is the number of feature quantities. “m” is the number of series in the relative frequency distribution. “Y” is the frequency of the corresponding feature in the original data in the corresponding class. “y” is the frequency of the corresponding feature in the extracted data in the corresponding class.

As shown in the above equation, the processing device 510 calculates, as an error, the sum of the errors of the frequencies in the respective classes for each feature between the relative frequency distribution in the entire original data and the relative frequency distribution in the extracted data.

After calculating the error, the processing device 510 advances the processing to S150. In S150 process, the processing device 510 determines whether the calculated error is less than or equal to the threshold value. The threshold value is a value for determining whether the extracted data having the relative frequency distribution close to the relative frequency distribution in the original data is extracted by the set clipping pattern. The magnitude of the threshold value is set in advance so that it can be determined that extracted data having a relative frequency distribution close to the relative frequency distribution in the original data is extracted based on the error being equal to or smaller than the threshold value.

In S150 process, when it is determined that the error is equal to or smaller than the threshold value (S150: YES), the processing device 510 advances the process to S160.

In S160 process, the processing device 510 calculates the intended index value using the extracted data generated in the latest process of S130. Here, an index value indicating the magnitude of the damage accumulated in the oil filter 36 is calculated. For example, the processing device 510 calculates the damage degree Sh as an index value indicating the degree of damage accumulated in the oil filter 36.

The damage degree Sh is an index value representing a ratio of the accumulated damage, assuming that the damage of the oil filter 36 gradually accumulates, with the damage leading to the damage being “1”. Here, the damage applied to the oil filter 36 during a certain period of time is calculated from the flow rate of the oil and the speed change frequency. Then, the ratio of damage that the oil filter 36 suffers from damage is set to “1”, and the calculated rate of damage is calculated as an index value. By repeating this, a damage degree Sh which is a ratio of accumulated damage to the calculated damage is calculated. When the damage degree Sh becomes “1”, the damage is caused, and the calculated damage degree Sh is a value from “0” to “1”.

Here, since the damage degree is calculated using the extracted data which is a part of the original data, the processing device 510 converts the calculated damage degree into a size corresponding to the original data, and calculates the damage degree Sh as the index value. For example, when the original data is traveling data for 100,000 hours and the extracted data is traveling data for 20,000 hours, the calculated degree of damage is multiplied by 5 to obtain the damage degree Sh as the index value.

On the other hand, in S150 process, when it is determined that the error is larger than the threshold value (S150: NO), the processing device 510 returns the process to S125. Then, the processing device 510 performs the search process up to S125 to S145 again.

In this way, the processing device 510 repeatedly performs S125 to S145 search processing by changing the settings of the plurality of time windows, and extracts extracted data in which the error becomes equal to or less than the threshold value from the original data. Then, the processing device 510 calculates an index value using the extracted data. After calculating the index value, the processing device 510 advances the processing to S170.

In S170 process, the processing device 510 determines whether the index value is equal to or greater than a predetermined value. The predetermined value is a value for predicting that damage is more likely to occur based on the fact that the index value is equal to or larger than the predetermined value. For example, “0.9” can be set here, for example, as a predetermined value in the damage degree Sh. In this case, it is possible to predict that the possibility of the damage is high based on the fact that the damage has reached 90% of the damage leading to the damage.

In S170 process, when it is determined that the index value is equal to or greater than the predetermined value (S170: YES), the processing device 510 advances the process to S180. In S180 process, the processing device 510 outputs an index value and a failure estimate. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs.

As shown in FIG. 7, for example, when the damage degree Sh calculated by using the extracted data extracted from the original data for 100,000 hours is the index value, the processing device 510 calculates the travel time until the damage degree Sh reaches “1” and outputs the calculated travel time as the life information. The processing device 510 may convert the information on the life into the travel distance based on the travel distance of 100,000 hours and output the converted information.

For example, the processing device 510 predicts the life of the oil filter 36 from the slope of the change in index value. The processing device 510 calculates the remaining travel time t until the damage degree Sh reaches “1” by using an approximate straight line or an approximate curve calculated based on the plurality of data of the damage degree Sh and the traveling time T.

The approximate curvilinear L1 indicated by the dashed line is calculated based on a plurality of data of the damage degree Sh and the traveling time T in a particular pre-maintenance period. The approximate curve L2 indicated by the solid line is calculated based on a plurality of data of the damage degree Sh and the traveling time T in the period after the particular maintenance. The approximate curve L2 includes a known duration Pb after a particular maintenance and up to the current Tr. The approximate curve L2 includes a predicted duration Pa after a particular maintenance and after a current Tr. For example, the processing device 510 calculates the damage degree Sh at predetermined intervals. The processing device 510 calculates an approximate curve based on the plurality of data of the damage degree Sh and the traveling time T for each predetermined period.

When there is a history of the specific maintenance, the processing device 510 calculates the remaining traveling time t up to the time Tov at which the damage degree Sh is predicted to reach “1” based on the damage degree Sh of the current Tr and the approximate curve L2 after the specific maintenance, and outputs the calculated remaining traveling time t as life information. For example, the processing device 510 calculates the remaining travel time t from the slope of the tangent line of the approximate curve L2 at the current Tr. The processing device 510 may calculate the remaining travel time t from the mathematical expression of the approximate curve L2. The processing device 510 may calculate the remaining travel time t from the slope of the approximate straight line or the mathematical expression of the approximate straight line.

In S170 process, when it is determined that the index value is less than the predetermined value (S170: NO), the processing device 510 advances the process to S190. In S190 process, the processing device 510 outputs an index value. Specifically, the processing device 510 transmits the index value to the information processing terminal 600 that has transmitted the instruction for requesting the analysis.

When S180 or S190 process is performed, the processing device 510 terminates the series of processes.

Operation of this Embodiment

The data center 500, which is the information processing device of the present embodiment, acquires original data collected and created over a predetermined period using a plurality of sensors mounted on the vehicle 10, and calculates an index value indicating the magnitude of damage accumulated in the oil filter 36.

The data center 500 includes a processing device 510 that performs a process. The original data includes data of the flow rate of the oil and data of the speed change frequency as features. In the data center 500, the search process performed by the processing device 510 includes a first step (S120) of calculating, for each feature, a relative frequency distribution in the original data for a plurality of feature quantities included in the original data. The searching process includes a second step (S125) of setting a plurality of time windows for clipping data of a part of the period of the original data such that the period of time of all the time windows is less than the predetermined period of time. In the second step (S125), the processing device 510 sets a plurality of time windows such that the ratios between data before the particular maintenance and data after the particular maintenance in the entire original data and the extracted data become equal. The search process includes a third step (S130) of clipping data from the original data by a plurality of time windows. The search process includes a fourth step (S140) of calculating, for each feature, the relative frequency distribution in the extracted data obtained by combining all the data clipped according to the plurality of time windows. The search process includes a fifth step (S145) of calculating an error between the relative frequency distribution in the original data and the relative frequency distribution in the extracted data. After performing the first step, the processing device 510 performs a search process in which the trial from the second step to the fifth step is repeatedly performed by changing the settings of a plurality of time windows. Then, the processing device 510 extracts the extracted data in which the error is equal to or less than the threshold value (S150: YES). The processing device 510 calculates an index value using the extracted data in which the error becomes equal to or smaller than the threshold value (S160).

According to the data center 500, it is possible to obtain extracted data in which features of the entire original data including a plurality of features are captured. Therefore, the data center 500 can calculate the index value with the same accuracy as in the case of using the original data by using the extracted data having a smaller data amount than the original data.

### Effect of this Embodiment

(1) According to the data center 500 that is the information processing device of the present embodiment, it is possible to achieve both reduction in the amount of data and calculation accuracy of the index value.

(2) According to the data center 500 which is the information processing device of the present embodiment, it is possible to calculate the index value in a shorter time than in the case where the original data is used.

(3) The processing device 510 performs clustering, which is machine learning for classifying the data of the sections obtained by dividing the original data into a predetermined number of clusters at regular intervals (S110). Then, in the second step (S125) of the search process, the processing device 510 sets a plurality of time windows such that the difference between the proportion of each cluster in the extracted data and the proportion of each cluster in the entire original data is equal to or less than the threshold value.

A plurality of intervals classified into the same cluster are intervals having similar characteristics. In the above-described search process, the setting output from the processing device 510 is a setting in which the difference in proportion of each cluster between the extracted data and the entire original data is equal to or less than the threshold value, and the extracted data having the relative frequency distribution of each feature close to that of the original data can be clipped.

Therefore, according to the search process performed by the data center 500, it is possible to find a setting that can obtain extracted data closer to the characteristics of the entire original data.

(4) In the second step (S125) of the search process, the processing device 510 sets a plurality of time windows so that the ratios of data before the specific maintenance and data after the specific maintenance in the entire original data and the extracted data become equal. Therefore, it is possible to find a setting in which extracted data closer to the feature of the entire original data can be obtained by taking into consideration the history of the specific maintenance.

(5) The processing device 510 terminates the search process when one piece of extracted data whose error becomes equal to or smaller than the threshold value can be extracted, and calculates an index value using the extracted data whose error becomes equal to or smaller than the threshold value. Therefore, the data center 500 can calculate an index value at a time point when one piece of extracted data whose error becomes equal to or smaller than the threshold value can be extracted, and output the result promptly.

(6) When the calculated index value is equal to or greater than the predetermined value (S170: YES), the processing device 510 notifies that a failure has been predicted. Therefore, the data center 500 can notify the user that the occurrence of the failure has been predicted before the failure occurs.

(7) The processing device 510 calculates the damage degree Sh as an index value. Therefore, the data center 500 can inform the user of how long the delay until the failure is reached.

(8) The processing device 510 predicts the life of the oil filter 36 from the slope of the change in index value. Therefore, the data center 500 can predict the life of the oil filter 36 according to the state of a change in index value after specific maintenance.

### Example of Change

The present embodiment can be modified and implemented as follows. The present embodiment and modification examples described below may be carried out in combination of each other within a technically consistent range.
As the features, the flow rate of the oil passing through the oil filter 36 for which the index value of the damage is to be calculated and the speed change frequency of the automatic transmission 30 are exemplified. The feature is not limited to this, and may include an engagement frequency of a clutch that can be connected so that the power of the engine 20 can be transmitted to the automatic transmission 30, or that can disconnect the engine 20 from the automatic transmission 30. The features may include an engagement frequency of the friction engagement element in the frictional engagement device 31. The features may include an engagement time of the frictional engagement element in the frictional engagement device 31. The features may include an engagement time of the lock-up clutch. The features may include a learned value of the shift control by the transmission control device 50.
In the above embodiment, an example in which the information processing device is embodied as the data center 500 has been described. An example in which the index value is calculated in the data center 500 has been described. On the other hand, the information processing device described above may be embodied as the information processing terminal 600. In this case, the calculation of the index value is performed by the processing device 610 of the information processing terminal 600. The above-described information processing device may be embodied as a control device of the vehicle 10. In this case, the calculation of the index value can also be performed by the control device of the vehicle 10. For example, the calculation of the index value may be performed by the transmission control device 50 of the vehicle 10.
In the above-described embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.
In the above-described embodiment, an example has been described in which, when the index value is equal to or larger than a predetermined value, it is notified that the occurrence of a failure has been predicted. This may be omitted. After the index value is calculated, only S190 process may be performed, and only the index value may be output.
Although the damage degree Sh is exemplified as the index value to be calculated, the index value to be calculated is not limited to the damage degree Sh. Specific maintenance may be component replacement and overhaul of the automatic transmission 30.
The index value of the damage of the plurality of oil filters 36 may be calculated. The relative frequency distributions of the respective feature quantities of the oil filters 36 may be calculated, and the clipping pattern may be searched so that the error of the relative frequency distributions of all the feature quantities becomes small.
For each oil filter 36, the clipping pattern may be searched so that the relative frequency distribution becomes smaller with respect to the feature. The index value may be calculated for each oil filter 36.
The present disclosure can also be applied to a transmission including an oil filter 36 other than the automatic transmission 30 described in the above embodiments, such as a stepped automatic transmission mounted on a hybrid electric vehicle, a forward/reverse switching mechanism of a continuously variable transmission, and a clutch of a manual transmission.
The processing device 510 sets a plurality of time windows such that a difference between the proportion of each cluster in the original data and the proportion of each cluster in the extracted data is equal to or smaller than a threshold value. Without such a restriction, the processing device 510 may set a plurality of time windows. In such cases, the process S110 in which clustering is performed may be omitted.
The method of determining the setting of the time window in the clipping pattern may not be random. The trial may be repeated by changing the setting of the time window in the clipping pattern according to a preset rule.
The error calculated in S145 process is not limited to the mean absolute error MAE. For example, the processing device 510 may calculate a mean square error as an error. The processing device 510 may calculate a root mean square error as an error.
An example using extracted data obtained by combining all the clipped data is shown. On the other hand, some of the clipped data may be combined to create extracted data.

What is claimed is:

1. An information processing device that reduces a volume of data to be used for analysis by extracting part of original data collected over a predetermined period using a plurality of sensors mounted on a vehicle, the information processing device comprising
a processing device configured to perform a process, wherein
the processing device is configured to perform a search process,
the search process including a first step of calculating, for each of a plurality of features included in the original data, a relative frequency distribution in the original data, a second step of setting a plurality of time windows for clipping data of a partial period of the original data in such a manner that a sum of periods of all the time windows is shorter than the predetermined period, a third step of clipping data from the original data according to the time windows, a fourth step of calculating, for each of the features, the relative frequency distribution in extracted data obtained by combining all the data clipped according to the time windows, and a fifth step of calculating an error between the relative frequency distribution in the original data and the relative frequency distribution in the extracted data, and after the first step is performed, a trial from the second step to the fifth step being repeatedly performed by changing settings of the time windows, and the processing device performing the search process to extract the extracted data with the error equal to or less than a threshold value, and
the processing device is configured to set, in the second step, the time windows in such a manner that ratios between data before specific maintenance and data after the specific maintenance in an entirety of the original data and the extracted data are equal.

2. The information processing device according to claim 1, wherein:
the processing device is configured to perform clustering, the clustering being machine learning that groups data of each interval obtained by dividing the original data into intervals of a certain period into a predetermined number of clusters; and
the processing device is configured to set, in the second step, the time windows in such a manner that a difference between a proportion of each of the clusters in the extracted data and a proportion of each of the clusters in the entirety of the original data is equal to or less than a threshold value.

3. The information processing device according to claim 1, wherein:
the specific maintenance is an oil change;
the original data includes data on a flow rate of oil as the feature; and
the processing device is configured to calculate an index value indicating a magnitude of damage accumulated in an oil filter by using the extracted data with the error equal to or less than the threshold value.

4. The information processing device according to claim 3, wherein the processing device is configured to, when the calculated index value is equal to or greater than a predetermined value, notify that a failure is predicted to occur.

5. The information processing device according to claim 3, wherein the processing device is configured to calculate the index value at predetermined time intervals and predict a service life of the oil filter from a slope of a change in the index value.
